(19) United States
(12) Patent Application Publication
(10) Pub. No.: US 2008/0019152 A1
(43) Pub. Date: Jan. 24, 2008

(54) Light-Source Holder, Illumination Device For Display Device, And Display Device

(75) Inventors: Kentoroh Aoki, Tokyo (JP); Motoaki Okitsu, Mie (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka-shi, Osaka (JP)

(21) Appl. No.: 11/722,893

(22) PCT Filed: Dec. 1, 2005
(86) PCT No.: PCT/JP05/22086

§ 371 Date: Jun. 27, 2007

(30) Foreign Application Priority Data
Jan. 6, 2005 (JP) 2005-001644

(51) Int. Cl. F21S 8/00

(52) U.S. Cl. 362/634; 362/432

(57) ABSTRACT

A lamp clip for holding a cold cathode tube onto a bottom plate part of a backlight case includes a body part adapted to be put into contact with the bottom plate part, a locking part protruding from the body part and being able to be locked onto the bottom plate part; and a plate spring part provided in the body part and adapted to bias the body part in a direction to be spaced apart from the bottom plate part. Upon assembling the lamp clip onto the bottom plate part, the body part is biased in a direction to be spaced apart from the bottom plate part due to the resilience of the plate spring part, thereby being locked in a state in which the locking face of the locking part is pressed against the peripheral margin of an insertion hole in the back surface of the bottom plate part. Thereby, it is possible to prevent backlash of the lamp clip with respect to the bottom plate part and prevent chattering sound from being generated. Further, a pair of plate spring parts are provided at opposed positions on either side of the locking part and projected in opposite directions to each other. This makes it possible to support the body part with good balance at both sides and fix it onto the bottom plate part without inclination.

### BACKGROUND OF THE INVENTION

1. Field of the Invention

The present invention relates to a light-source holder, an illumination device for a display device, and a display device.

2. Description of the Related Art

In a non-luminescent display device such as a liquid crystal display device, a backlight unit is provided at the back surface of a panel so as to illuminate it. See, for example, Japanese Patent Laid-Open No. 2001-210126. This backlight unit is configured such that a plurality of light sources such as cold cathode tubes are arranged in parallel and contained inside a case which is formed into a shallow pan shape.

These light sources are fixed to the bottom plate of the case with a light-source holder, such as a lamp clip formed of resin, etc. This lamp clip is configured such that in its body part there is provided on a surface opposed to the case bottom plate an engaging part for engaging with the case, and on the opposite surface a clipping part for holding the light source. The engaging part includes a base part protruding from the body part and a locking head of a large diameter provided at the protruding end of the base part. Thus, the base part is inserted into a mounting hole provided in the case bottom plate and the locking head is locked onto the peripheral margin of the mounting hole in the back surface of the bottom plate so that the lamp clip is locked onto the bottom plate.

However, since there is a certain dimensional tolerance in the production stage, the distance between the body part and the locking head of the lamp clip may become larger than the thickness of the case bottom plate. In such a case, backlash between the attached lamp clip and the bottom plate of the case is experienced, and thus, there is risk that a chattering sound or the like may be generated due to the vibration of the device or the like.

### SUMMARY OF THE INVENTION

In order to overcome the problems described above, preferred embodiments of the present invention provide a light-source holder that prevents backlash between the light-source holder and the holding wall for the light-source holder.

The light-source holder according to a preferred embodiment of the present invention, which is intended to hold a light source on a holding wall, includes a body part adapted to be put into contact with the holding wall, a locking part protruding from the body part toward the holding wall and being arranged to be locked onto the holding wall, and a spring part provided in the body part on a surface opposed to the holding wall and adapted to bias the body part in a direction so as to be spaced apart from the holding wall. In the light-source holder according to a preferred embodiment of the present invention, the benefits of this preferred embodiment of the present invention can be achieved as long as a spring part is provided at least one or more places in the body part.

In one preferred embodiment of the light-source holder of the present invention, a spring part may be provided at least two places on either side of the locking part. Such a configuration can restrict the inclination of the body part with respect to the holding wall thereby anchoring the body part to the holding wall with good balance. In another preferred embodiment of the light-source holder of the present invention, at least one pair of the springs may be provided at positions opposed to each other. Such a configuration can restrict the inclination of the body part with respect to the holding wall thereby anchoring the body part with good balance.

In a further preferred embodiment of the light-source holder of the present invention, the spring part may be a plate spring which is integrally formed with the body part and is projected toward the holding wall in a cantilever arrangement. According to such a configuration, since the spring part can be integrally formed with the body part, it is possible to decrease production steps thereby reducing cost compared with the case in which a spring part which is formed separately from the body part is attached to the body part. In this case, at least one pair of plate spring parts may be projected in opposite directions from each other. Such a configuration can restrict the inclination of the body part with respect to the holding wall thereby anchoring it with good balance.

In a further preferred embodiment of the light-source holder of the present invention, the spring part may be provided at at least one place between a plurality of locking parts. Such a configuration can also restrict the inclination of the body part with respect to the holding wall thereby anchoring the body part with good balance.

In a further preferred embodiment of the light-source holder of the present invention, the configuration may be such that two or more light sources can be held by one light-source holder. Such a configuration can reduce the number of parts and thereby simplify the production process.

The light-source holder according to a preferred embodiment of the present invention can be preferably applied to an illumination device for a display device. That is, the illumination device for a display device according to a preferred embodiment of the present invention includes a light-source holder having the above described configurations, a light source to be held by the light-source holder, and a case part having the above described holding wall and arranged to accommodate the above described light source and light-source holder. In one preferred embodiment of the illumination device for a display device according to the present invention, the light-source holder may be formed of polymeric material, for example. With polymeric material, it is possible to produce a light-source holder having a spring part at low cost and with ease by, for example, an injection molding thereby reducing the cost. Also in another preferred embodiment of the illumination device for a display device according to the present invention, the light-source holder may have a white color. Instead, the light-source holder may have a milky-white color. Further, the light-source holder may be transparent. According to such a configuration, it is possible to avoid the deficiencies such as a decline in luminance due to the blockage of light by the light-source holder since the light from the light source is reflected from or transmits through the light-source holder.

The above-described illumination device for a display device is preferably applied to a display device. That is, the display device according to a preferred embodiment of the present invention is configured such that an illumination device for a display device having the above described configurations, an optical member for diffusing the light from the illumination device for a display device, and a non-luminescent display panel are laminated in this order. In one preferred embodiment of the display device of the present invention, the display panel may be configured to electrically control the deflection property of electro-magnetic wave. In a further preferred embodiment, the display panel may be configured to control the intensity of electro-magnetic wave by a physical or mechanical shuttering scheme. In a further preferred embodiment, the display panel may be a liquid crystal display panel, and the display device may be a liquid crystal display device.

According to a preferred embodiment of the present invention, when attaching the light-source holder to the holding wall, the body part is biased in a direction so as to be spaced apart from the holding wall by the resilience of the spring part, and thereby locked in a state in which the locking part is pressed against the peripheral margin of the insertion hole in the back surface of the holding wall. In this way, it is possible to prevent the backlash between the light-source holder and the holding wall thereby preventing a chattering sound or the like from being generated.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view illustrating the liquid crystal display according to a first preferred embodiment of the present invention.

FIG. 2 is a partially enlarged perspective view illustrating the backlight unit according to the first preferred embodiment of the present invention.

FIG. 3 is a perspective view illustrating the lamp clip of the first preferred embodiment of the present invention.

FIG. 4 is a front view illustrating the lamp clip of the first preferred embodiment of the present invention.

FIG. 5 is a side sectional view illustrating the state before the lamp clip of the first preferred embodiment is attached to the case.

FIG. 6 is a side sectional view seen from the short side of the lamp clip, illustrating the state after the lamp clip is attached to the case.

FIG. 7 is a side sectional view seen from the long side of the lamp clip, illustrating the state after the lamp clip is attached to the case.

FIG. 8 is a front view illustrating the lamp clip according to a second preferred embodiment of the present invention.

FIG. 9 is a side sectional view illustrating the state before the lamp clip is attached to the case.

FIG. 10 is a side sectional view illustrating the state after the lamp clip is attached to the case.

FIG. 11 is a perspective view to show the lamp clip according to another preferred embodiment of the present invention.

### DETAILED DESCRIPTION OF PREFERRED EMBODIMENTS

### First Preferred Embodiment

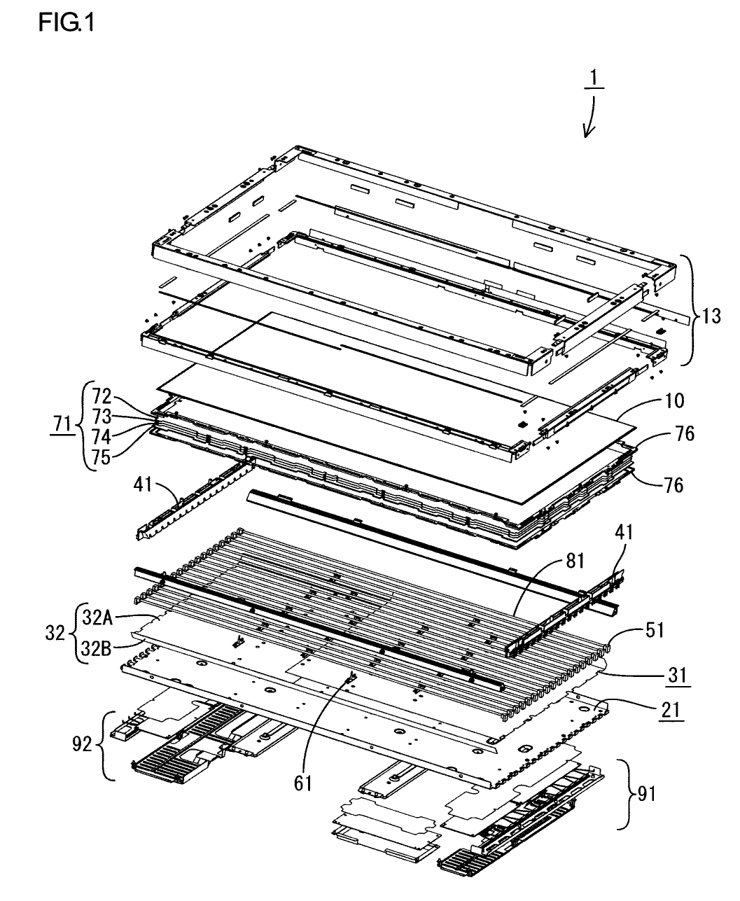

Hereinafter, a first preferred embodiment of the present invention will be described in detail with reference to FIGS. 1 to 7. FIG. 1 shows an exploded perspective view of the liquid crystal display 1 according to a preferred embodiment of the present invention (corresponding to the display device of the present invention). The liquid crystal display 1 includes a liquid crystal display panel 10 of a non-luminescent type having no self-luminous element (corresponding to the display panel according to preferred embodiments of the present invention), an optical member 71 disposed in the back surface side of the liquid crystal display panel 10, and a backlight unit 20 (corresponding to the illumination device for a display device of the present invention) adapted to be assembled from the back surface side of the liquid crystal display panel 10 and the optical member 71; these components are adapted to be held together in one piece by a bezel 13. Moreover, in the following description, the display surface side (upward in FIG. 1) of the liquid crystal display panel 10 is referred to as a front surface side, and the opposite side (downward in FIG. 1) as a back surface side.

The liquid crystal display panel 10, though not shown in detail, has a well known structure in which a pair of glass substrates having a substantially rectangular plate shape, on which switching elements (for example, TFTs), pixel electrodes, and others for forming pixels are arranged in a matrix form, are bonded together with a predetermined gap and liquid crystal material is sealed in between both the glass substrates. The outer surfaces (the surface opposite to the liquid crystal layer) of both the glass substrates are laminated with a polarizing plate which have approximately the same size as each glass substrate.

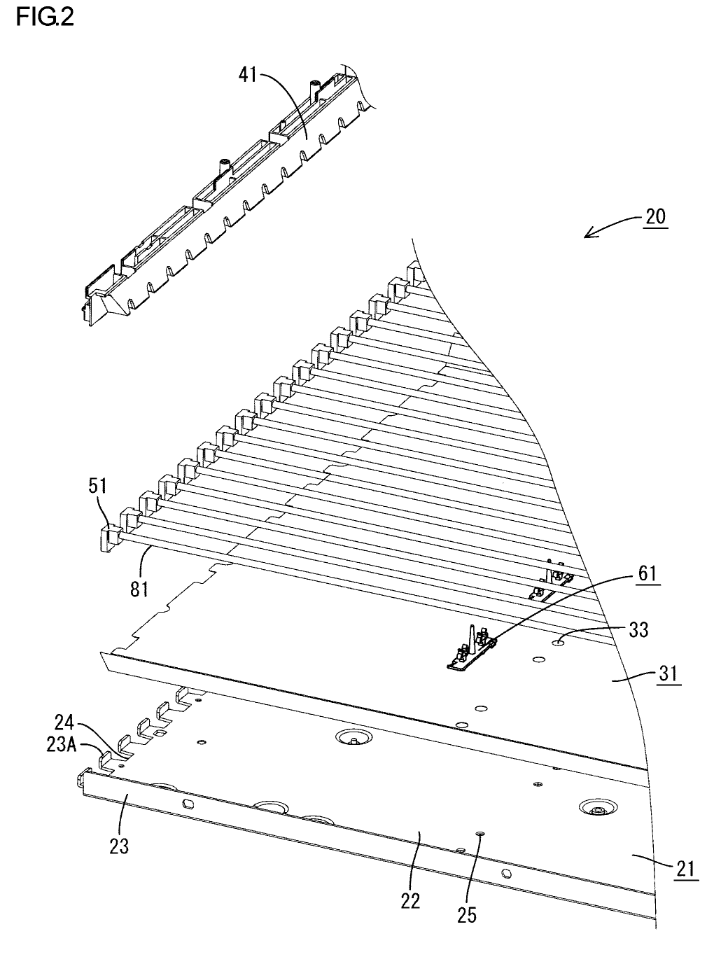

The backlight unit 20, which is to be attached in the back surface side of the liquid crystal display panel 10 is of a direct type in which the light source is disposed in the back surface of the liquid crystal display panel 10, includes a backlight case 21 made of metal (corresponding to the case part of the present invention; hereinafter, abbreviated as “case 21”), and a plurality of cold cathode tubes 81 contained in the case 21 (corresponding to the light source of the present invention, see also FIG. 2).

The case 21 includes a bottom plate part 22 having a substantially rectangular plate shape (corresponding to the holding wall of the present invention), which has approximately the same size as the liquid crystal display panel 10, and a side wall part 23 which is raised respectively from each of the four sides of the bottom plate part 22 toward the front face side, the case as a whole being formed approximately into an shallow pan shape with an opening in the front surface side. There are provided at an even pitch in either short side of this case 21 a large number of fit-in grooves 24, which are formed by cutting off the bottom plate part 22 from the raised end of the side wall part 23A of a short side to a position at a certain short distance inward toward the center from the short side, and into which a rubber holder 51 described later can be fitted (see FIG. 2). Further, in the bottom plate part 22, there is provided at the attachment position of a lamp clip 61 described later a pair of insertion holes 25 associated with each lamp clip 61.

In the case 21, a reflection sheet 31 for reflecting the light emitted from a cold cathode tube 81 (described later) is laid. The reflection sheet 31 is preferably a white sheet formed of synthetic resin, and is formed by alternately combining two divided sheets 32 having the same shape. Each divided sheet 32 is preferably configured as follows: a bottom-plate side sheet piece 32A, which matches with the bottom plate part 22 of the case 21, is divided into two pieces at the central position in the lengthwise direction thereof; and a side part of each divided piece along the long side of the case 21 is respectively connected with a side-wall side sheet 32B, which matches the side wall part 23 on the long side of the case 21. This reflection sheet 31 is provided with an attachment hole 33 at a position which matches with each insertion hole 25 of the case 21 described above.

There is provided on the reflection sheet 31 a cold cathode tube 81 which is a light source. The cold cathode tube 81 preferably includes a tube body elongated in the long-side direction of the case 21, and a plurality of the cold cathode tubes 81 are disposed in parallel along the short-side direction of the case 21. There is provided at the end of the cold cathode tube 81 an electrode part, although not shown in detail, from which an electric wire is led out. Further, each end of the cold cathode tube 81 is held by a rubber holder 51 which is disposed on each short-side part of the case 21, and is covered as a whole together with the rubber holder 51 by a lamp holder 41 (see FIG. 2).

Further, the cold cathode tube 81 is held at a position which is closer to its center than to its end by a lamp clip 61 (corresponding to the light-source holder of the invention). The lamp clip 61, which is preferably formed as one piece from synthetic resin, is attached to the inner wall surface of the bottom plate part 22 of the case 21 thereby holding the cold cathode tubes 81 at positions closer to its center than to its ends. The lamp clips 61, each of which is capable of holding cold cathode tubes 81 in a set of two rows, are provided at two places for each set (2 rows) of cold cathode tubes 81, and the lamp clips 61 for supporting cold cathode tubes 81 in adjoining sets are disposed in a staggered configuration. Further, since the lamp clip 61 is to be disposed in the display area of the liquid crystal display panel 10, when it is adapted to have a color which absorbs the light for example from the cold cathode tube 81, there is risk of causing deficiencies such as a decline of luminance. To avoid this, the lamp clip 61 is adapted to have a white color so that it can reflect the light from the cathode tube 81 in the same way as the reflection sheet 31.

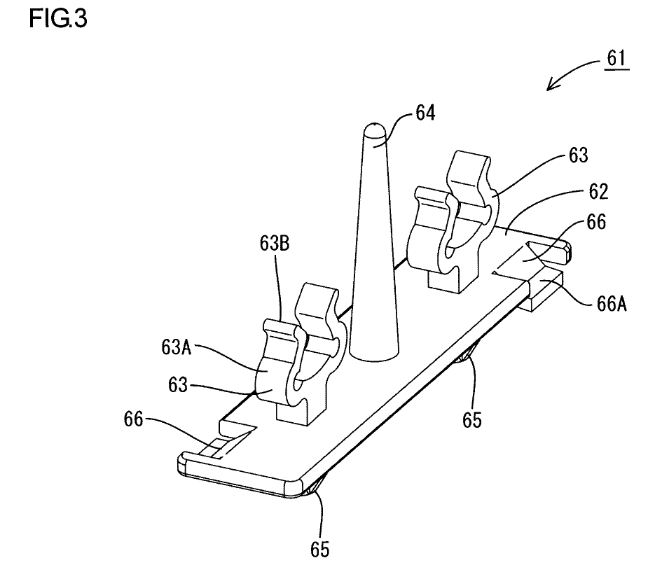

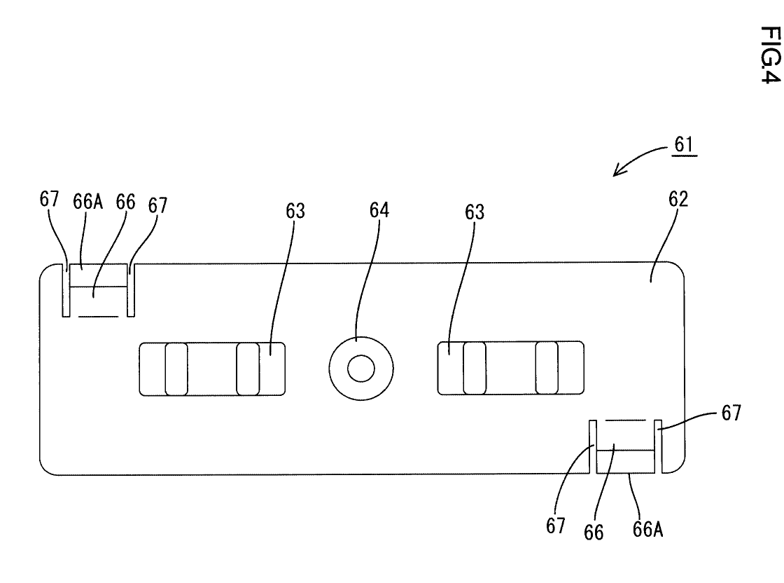

The lamp clip 61 preferably includes a body part 62 having an elongated, substantially rectangular plate shape along the short-side direction of the bottom plate part 22 (a direction normal to the length of the cold cathode tube 81). There are provided on the front surface side of the body part 62 (the other side of the surface opposed to the bottom plate part 22), two clipping parts 63 for holding the cold cathode tube 81, disposed in parallel along the lengthwise direction of the body part 62 (see FIGS. 3 and 4). The clipping part 63 preferably includes a pair of annular pieces 63A which are expandable relative to each other in the lengthwise direction of the body part 62, and are formed as a whole into a substantially C-shaped ring having an opening in its circumference. There are provided at the tip ends of the pair of annular pieces 63A, guide parts 63B which are adapted to be bent in a direction to be spaced apart from each other and to guide the mounting of the cold cathode tube 81 to the clipping part 63. When the cold cathode tube 81 is forced through the opening part of the annular piece 63A, both the annular pieces 63A are deformed in such a way to expand the opening thereby allowing the passage of the cold cathode tube 81, and when the cold cathode tube 81 has entered inside, both the annular pieces 63A elastically restore their original shape and come into an elastic contact with the outer periphery of the cold cathode tube 81 thereby holding the cold cathode tube 81. There is provided between the two clipping parts 63 a conical pin 64 which is tapered at its tip end. The pin 64 is adapted to have a length to allow the tip end of the lamp clip 61 to reach near the opening of the case 21 when the lamp clip 61 is attached to the case 21, so as to serve to support the optical member 71 described below from the back surface side.

Further, there is provided in the back surface side (on the side of the surface opposed to the bottom plate part 22 of the case 21) of the body part 62 a pair of locking parts 65 for fixing the lamp clip 61 to the bottom plate part 22. Each locking part 65 is located exactly on the other side of each clipping part 63, respectively. The locking part 65 includes a base part 65A which is vertically disposed on the back surface of the body part 62, and a pair of elastic locking pieces 65B which is projected diagonally forward from the tip part of the base part 65A, i.e. toward the body part 62 while becoming spaced apart from the base part 65A. Both the elastic locking pieces 65B are configured in the form of a cantilever connected to both sides of the tip part of the base part 65A, and adapted to be elastically deformable in the direction moving closer to or away from the base part 65A by being pivoted at the connection portion. The projection end of the elastic locking piece 65B is formed with steps, in which the step outwardly located in the expanding direction is reduced in its height (recessed in the direction away from the body part 62). The surface of the outwardly located step with a reduced height is adapted to serve as a locking surface 65C to be locked onto the peripheral margin of the insertion hole 25 in the back surface of the case 21. The space between the back surface of the body part 62 and the locking surface 65C is adapted to be approximately equal to or slightly larger than the thickness of the bottom plate part 22.

Moreover, there are provided in the body part 62 a pair of plate spring parts 66 each of which is formed into a cantilever form. The two plate spring parts 66 are provided near opposite ends of the pair of long-side parts in the body part 62, that is, at opposite positions on either side of the two locking parts 65. Each plate spring part 66 is configured such that two parallel slits 67 along the short-side direction are provided near the end part of each long-side part in the body part 62, and a cut-in piece formed between the slits 67 is configured to be slanted in such a way to descend toward the back surface direction (toward the surface where the locking part 65 is formed) progressively toward the outside (edge side). The plate spring parts 66 are projected to a position which is located slightly closer to the back surface than the projection end of the elastic locking piece 65B is, and the tip part of the plate spring part is extended in parallel with the plate surface of the body part 62. Thus, the tip part is configured as a contact part 66A to be put into contact with the bottom plate part 22 when the lamp clip 61 is attached to the case 21.

There is attached at the opening part of the case 21 in such a way to cover the opening part, an optical member 71 for diffusing the light from the cold cathode tube 81, which is a linear light source, and emitting it to the liquid crystal display panel 10 as uniform planar light. The optical member 71 preferably is configured such that a diffusion sheet 72, a lens sheet 73, an optical sheet 74, and a diffusion plate 75 are superposed from the front surface side in that order. Each sheet 72, 73, 74, 75 preferably has a substantially rectangular shape of almost the same size as the liquid crystal display panel 10, and is supported from the back surface side by a pin 64 of the lamp clip 61. Further, a frame 76 for the attachment of the optical member 71 is disposed respectively in the front surface side and back surface side thereof. Further, there is attached in the back surface of the case 21 an inverter unit 91 and an external circuit unit 92 for controlling the lighting of the cold cathode tube 81.

Next, the function and effects of preferred embodiments of the present invention configured as described above will be described.

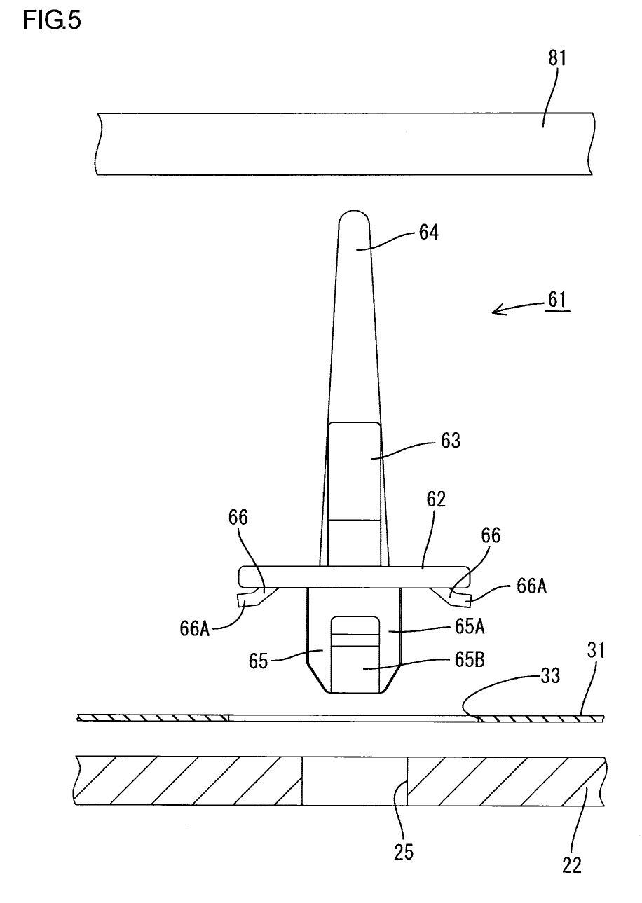

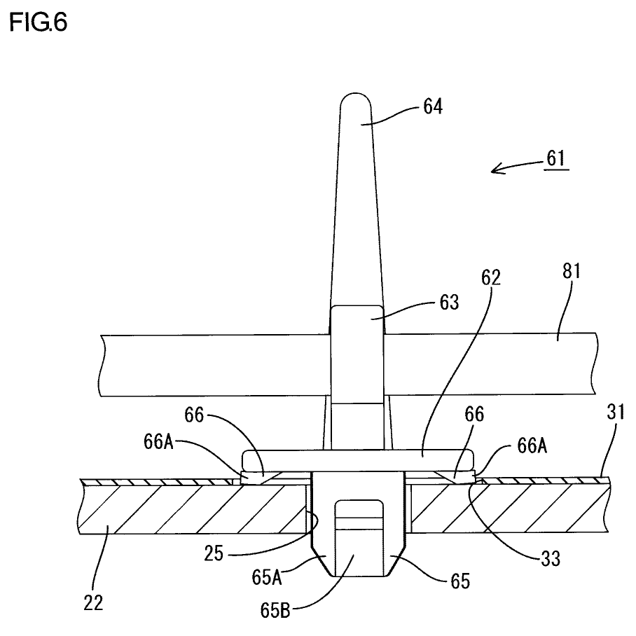

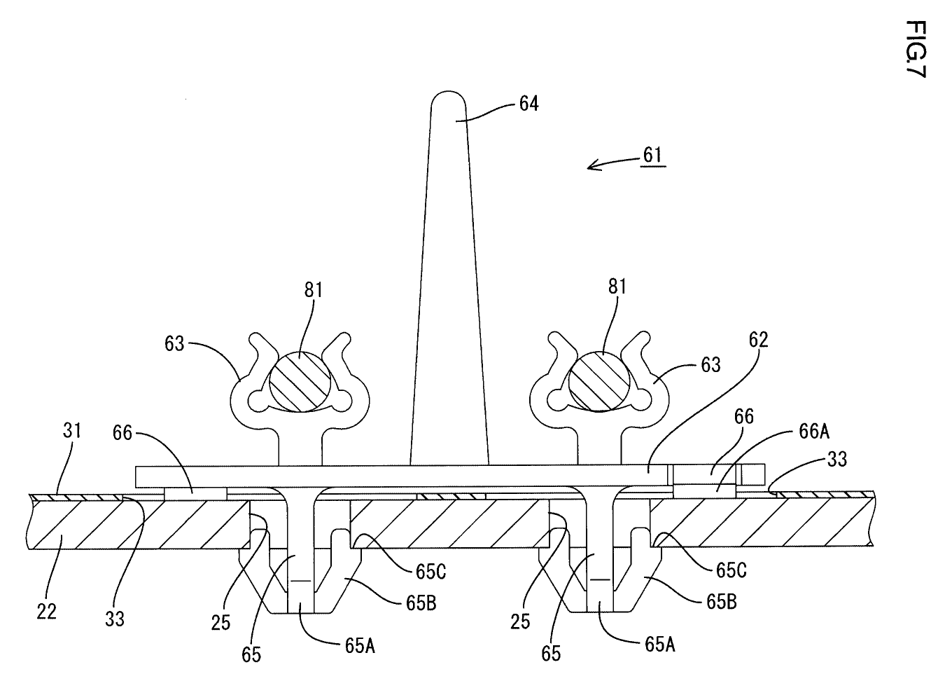

In assembling the liquid crystal display 1, a reflection sheet 31 is laid on the bottom plate part 22 of the case 21. Then, over the reflection sheet 31, the lamp clip 61 is attached to the bottom plate part 22 (FIG. 5). Upon inserting the locking part 65 of the lamp clip 61 into the insertion hole 25 via the attachment hole 33, the elastic locking piece 65B is once elastically deformed in such a way to get closer to the base part 65A. Then, at the moment when the locking part 65 is forced into to a predetermined depth, the elastic locking piece 65B restores so that the locking surface 65C provided at its tip part is locked onto the peripheral margin of the insertion hole 25 in the back surface of the bottom plate part. This causes the lamp clip 61 to be fixed to the bottom plate part 22 (FIGS. 6 and 7). At this moment, the contact part 66A is pressed against the bottom plate part 22 and thereby the two plate spring parts 66 are elastically deflected in the direction to get closer to the body part 62, and the elastic restoration force biases the body part 62 in a direction to be spaced apart from the bottom plate part 22 of the case 21. This causes the locking surface 65C of the locking part 65 to be held in close contact with the peripheral margin of the insertion hole 25 in the back surface of the bottom plate part, thus making the lamp clip 61 to be held to the bottom plate part 22 without backlash. Further, there are provided a pair of plate spring parts 66 at opposed positions on either side of the locking part 65 and each of them is projected in the outward direction (opposite directions to each other), respectively. This makes it possible to support the body part 62 at both sides with good balance and anchor it onto the bottom plate part 22 without inclination.

When the lamp clip 61 has been attached, the cold cathode tubes 81, each of which is attached with a rubber holder 51 at its end, are placed in parallel in the case 21, and the tube body of the cold cathode tube 81 is supported by the clipping portion 63 of the lamp clip 61. Then, the lamp holder 41 is fit into the case 21 in such a way to cover the rubber holder 51. Then, the optical member 71, the frame 76, the inverter unit 91, and the external circuit unit 92 are assembled to the case 21 thus completing the assembly of the backlight unit 20. Finally, the backlight unit 20 is assembled from the back surface side of the liquid crystal display panel 10 and fixed by the bezel 13 thereby completing the liquid crystal display 1.

In using the liquid crystal display 1, the light emitted from the cold cathode tube 81, which is provided in the backlight unit 20, enters into the optical member 71 directly and by being reflected by the reflection sheet 31 on the back surface side, and is irradiated from the back surface side of the liquid crystal display panel 10 in a state of being diffused by the optical member 71 thereby causing a display on the liquid crystal display panel 10 to be visually recognized.

At this moment, since the lamp clip 61 is white colored so as to reflect the light from the cold cathode tube 81 as well as the reflection sheet 31, it is possible to avoid deficiencies such as a decline of luminance due to the blockage of light by the lamp clip 61.

As so far described, according to the present preferred embodiment, when the lamp clip 61 is attached to the bottom plate part 22, the body part 62 is biased in a direction to be spaced apart from the bottom plate part 22 by the resilience of the plate spring part 66, and is locked in a state that the locking surface 65C of the locking part 65 is being pressed against the peripheral margin of the insertion hole 25 in the back surface of the bottom plate part. This prevents the backlash between the lamp clip 61 and the bottom plate part 22, thereby making it possible to prevent a chattering sound and the like from being generated. Further, a pair of plate spring parts 66 are provided at opposed positions on either side of the locking part 65, and projected in opposite directions to each other. This makes it possible to support the body part 62 at both sides with good balance and anchor it to the bottom plate part 22 without inclination.

Further, since the plate spring part 66 is integrally formed with the body part 62, it is possible to reduce production steps compared with a case in which a spring body formed separately from the body part 62 is attached to the body part 62, thereby reducing cost. Further, since by forming the lamp clip 61 with resin, it is possible to produce a lamp clip 61 including a plate spring part 66 easily at low cost by, for example, an injection molding, cost reduction may be achieved. Further, by making the lamp clip 61 to have a white color so as to be able to reflect the light from the light source in the same way as the reflection sheet 31, it is possible to avoid deficiencies such as a decline of luminance.

### Second Preferred Embodiment

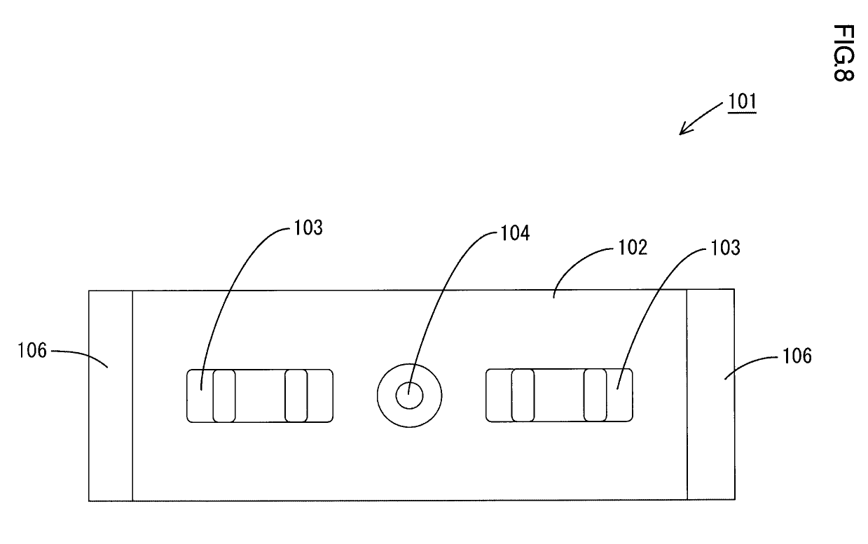

Hereinafter, the second preferred embodiment of the present invention will be described in detail with reference to FIGS. 8 to 10. The lamp clip 101 of the present preferred embodiment includes a body part 102 having a substantially rectangular plate form as in the case of the first preferred embodiment, and the body part 102 is provided in its back and front surfaces with a clipping part 103, a pin 104, and a locking part 105 having a similar shape to those of the first preferred embodiment (FIG. 8).

In the body part 102, both ends in the long-side direction is inclined so as to progressively descend toward the back surface side (where the locking part 105 is provided) starting from a point slightly inside the edge of the short side, and this inclined part is provided as the plate spring part 106. The inclination of these plate spring parts 106 is adjusted such that its tip part (edge of short side) is located slightly closer to the back side than the projection end of the elastic locking piece 105B. Since other configurations are the same as those of the first preferred embodiment, the like numbers are used to omit explanations.

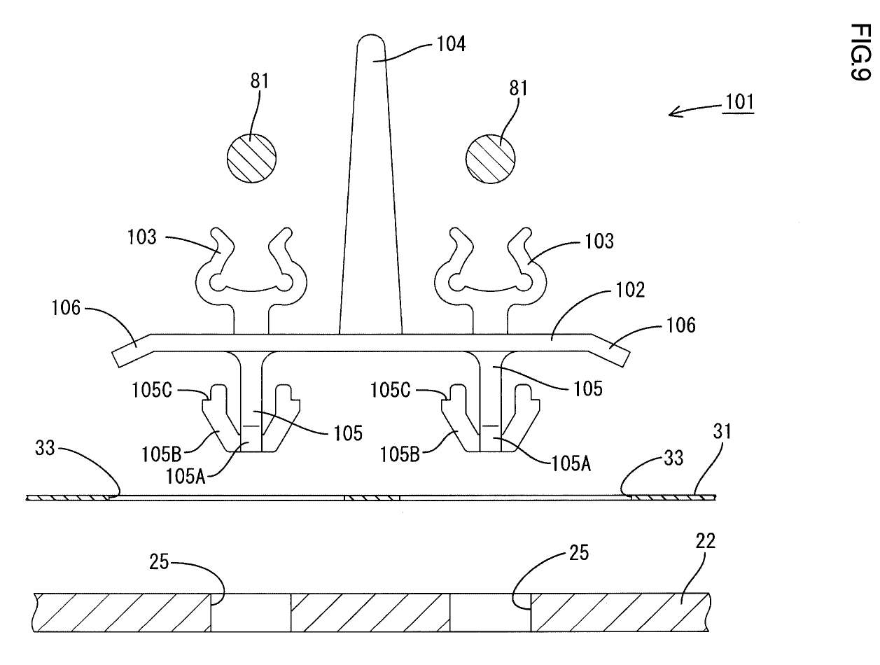

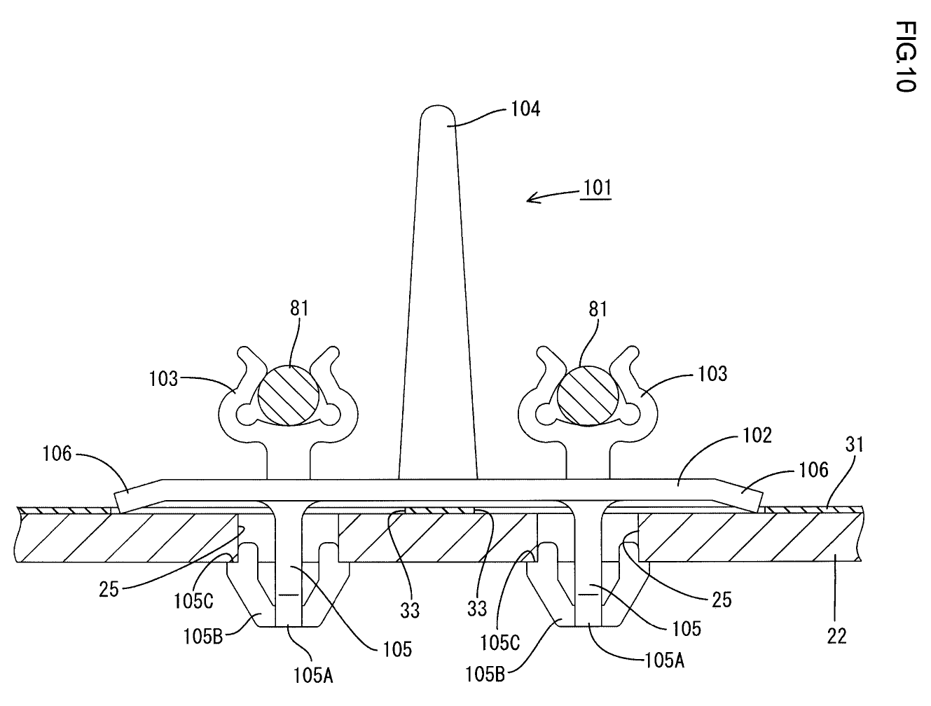

In assembling the liquid crystal display of the present preferred embodiment, a reflection sheet 31 is laid on the bottom plate part 22 of the case 21 as in the case of the first preferred embodiment and over the reflection sheet 31, the lamp clip 101 is attached (FIG. 9). Upon inserting the locking part 105 of the lamp clip 101 into the insertion hole 25 via the attachment hole 33, the elastic locking piece 105B is locked onto the peripheral margin of the insertion hole 25 in the back surface of the bottom plate part (FIG. 10) as in the case of the first preferred embodiment. At this moment, the tip parts (the edge of the short side of the body part 102) of two plate spring parts 106 are pressed against the bottom plate part 22 and thereby the two plate spring parts 106 are elastically deflected toward the front surface side, and bias the body part 102 by its restoring force in the direction to be spaced apart from the bottom plate part 22 of the case 21. This causes the locking surface 105C of each locking part 105 to be in close contact with the peripheral margin of the insertion hole 25 in the back surface of the bottom plate part, so that the lamp clip 101 is held against the bottom plate part 22 without backlash. Once the lamp clip 101 is attached, other members are assembled one after another to complete the liquid crystal display as in the first preferred embodiment.

As described so far, the present preferred embodiment can also achieve similar effects to those of the first preferred embodiment.

### Other Preferred Embodiments

The scope of the present invention will not be limited by the above described preferred embodiments. For example, the following other preferred embodiments are included in the scope of the present invention. Further, the scope of the present invention will cover equivalent variations.

(1) Although in each of the above-described preferred embodiments, the plate spring part 66, 106 preferably is integrally formed with the body part 62, 102 of the lamp clip 61, 101, the spring part may be separately formed and attached to the body part. Further, the configuration of the spring part will not be limited by the present preferred embodiments, and it may be a plate spring of a both-ends support type, a compressed coil spring, rubber, or the like.

(2) Although in the first preferred embodiment, the plate spring parts 66 preferably are projected respectively in the outward directions of the body part 62 in the lamp clip 61, a pair of plate spring parts may be projected respectively in the inward directions of the body part. Further, a pair of the plate spring parts may be projected in the same direction.

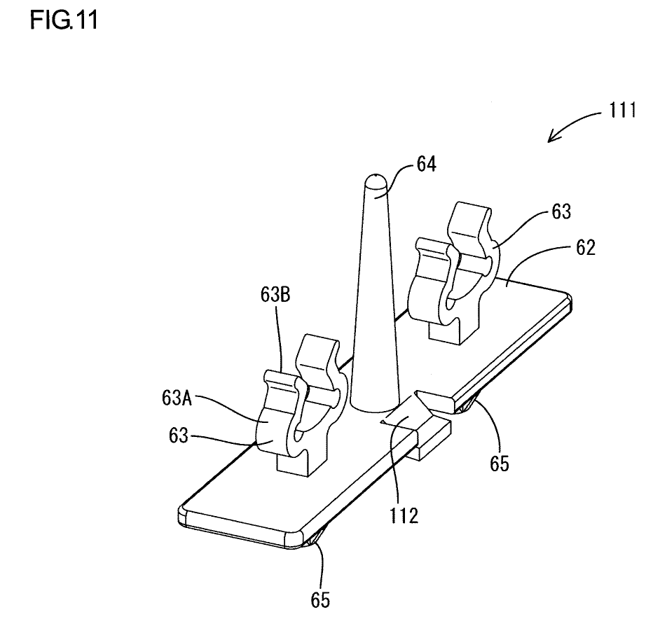

(3) Although in each of the above described preferred embodiments, there are preferably provided a pair of plate spring parts 66, 106 on either side of two locking parts 65, 105, one plate spring part 112 may be provided at a position between the locking parts 65 as shown by a lamp clip 111 in FIG. 11, for example.

(4) Although in each of the above described preferred embodiments, there are preferably provided a pair of plate spring parts 66, 106 on either side of two locking parts 65, 105, a pair of spring parts may be provided on either side of each of a plurality of locking parts.

(5) Although in each of the above described preferred embodiments, the lamp clips 61, 101 are preferably formed to be white in color, the lamp clip may be formed in a milky-white color or to be transparent allowing the transmission of light; in short, any configuration will suffice as long as no luminance decline occurs.

(6) Although, in the above described preferred embodiments, the present invention is preferably applied to the liquid crystal display 1, the present invention may be applied to any display device having a backlight device at the back face side of the display panel. Further, although the liquid crystal display panel 10 is configured to electrically control the deflection property of electro-magnetic wave (light), without being limited by this, the display panel may be configured to control the intensity of electro-magnetic wave by a physical or mechanical shuttering scheme.

(7) Although in the above described preferred embodiments, there are preferably provided two clipping parts 63 for one lamp clip 61 so as to be able to hold two cold cathode tubes 81, for example only one or not less than three clipping parts may be provided for one light-source holder so as to hold only one, or not less than three light sources.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-19. (canceled)

20: A light-source holder comprising:
a body part adapted to be put into contact with a holding wall, said holding wall being adapted to be attached with a light source;
a locking part protruding from said body part toward said holding wall and being able to be locked onto said holding wall; and
a spring part provided in said body part on a surface opposed to said holding wall and adapted to bias said body part in a direction to be spaced apart from said holding wall.

21: The light-source holder according to claim 20, wherein said spring part includes a first spring part and a second spring part, and the first and second spring part are positioned on either side of said locking part.

22: The light-source holder according to claim 21, wherein first and second spring parts are provided at positions opposed to each other.

23: The light-source holder according to claim 20, wherein said spring part is a plate spring part which is integral with said body part and extends toward said holding wall in a cantilever arrangement.

24: The light-source holder according to claim 21, wherein said spring part is a plate spring part which is integral with said body part and extends toward said holding wall in a cantilever arrangement.

25: The light-source holder according to claim 22, wherein said spring part is a plate spring part which is integral with said body part and extends toward said holding wall in a cantilever arrangement.

26: The light-source holder according to claim 23, wherein said plate spring part is positioned on a first and second side of the body part, and the plate spring parts extend in opposite directions from each other.

27: The light-source holder according to claim 24, wherein said plate spring part is positioned on a first and second side of the body part, and the plate spring parts extend in opposite directions from each other.

28: The light-source holder according to claim 25, wherein said plate spring part is positioned on a first and second side of the body part, and the plate spring parts extend in opposite directions from each other.

29: The light-source holder according to claim 20, wherein the locking part includes a plurality of locking parts, and said spring part is provided between the plurality of locking parts.

30: An illumination device for a display device, comprising:
a light source;
a case part containing said light source and including:
a holding wall adapted to be attached with said light source; and
a light-source holder including a body part arranged to contact with said holding wall, a locking part protruding from said body part toward said holding wall, the locking part arranged to be locked onto said holding wall, and a spring part provided in said body part on a surface opposed to said holding wall and arranged to bias said body part in a direction to be spaced apart from said holding wall.

31: The illumination device for a display device according to claim 30, wherein said light-source holder is made of polymeric material.

32: A display device for an illumination device comprising:
a light source;
a case part containing said light source and including a holding wall adapted to be attached with said light source;
a light-source holder, said light-source holder including a body part arranged to contact with said holding wall, a locking part protruding from said body part toward said holding wall, the locking part arranged to be locked onto said holding wall, and a spring part provided in said body part on a surface opposed to said holding wall and arranged to bias said body part in a direction to be spaced apart from said holding wall; and
an optical member arranged to diffuse the light from said illumination device and a non-luminescent display panel.

33: The display device according to claim 32, wherein said display panel is a liquid crystal display panel, and said display device is a liquid crystal display device.
